(19) United States
(12) Patent Application Publication
(10) Pub. No.: US 2010/0111094 A1
(43) Pub. Date: May 6, 2010

(54) RELAY DEVICE, ACCESS ANALYSIS DEVICE, METHOD OF CONTROLLING RELAY DEVICE, AND STORAGE MEDIUM FOR THE SAME

(75) Inventors: Yasutaka TANIKAWA, Kawasaki (JP); Yoshihiro Kimura, Kawasaki (JP); Toshiaki Hayashi, Kawasaki (JP); Ikuko Tachibana, Kawasaki (JP); Takashi Tanifuji, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/607,704

(22) Filed: Oct. 28, 2009

(30) Foreign Application Priority Data
Oct. 31, 2008 (JP) 2008-282194

(51) Int. Cl. H04L 12/56

(52) U.S. Cl. 370/401

(57) ABSTRACT

When transmitting, to an information processing device (such as a server) via a telecommunications line, a plurality of pieces of information obtained in a target device that is a target of maintenance, a relay device (computer) refers to priority recognition information used to recognize priority in transmitting the pieces of maintenance information in order to determine the priority of each of the pieces of maintenance information, and transmits the plurality of pieces of maintenance information separately and sequentially to the information processing device via the telecommunication line on the basis of the determined priority.

### CROSS-REFERENCE TO RELATED APPLICATION

This application is based upon and claims the benefit of priority of prior Japanese Patent Application No. 2008-282194, filed on Oct. 31, 2008, the entire contents of which are incorporated herein by reference.

### FIELD

The embodiments discussed herein are related to a technology of transmitting, to an information processing device in a maintenance center or the like via a telecommunications line, maintenance information obtained in a maintenance target device.

### BACKGROUND

Usually, maintenance services for responding to problems in products are provided by the companies that have produced/sold the products, e.g., hardware such as servers operating as information processing devices, storage devices operating as electromagnetic storage devices, or software such as application programs, etc. Those services are provided in order to allow the customers to use the products more comfortably. One of the methods of providing such maintenance services is a method in which problems are responded to by a “front line” and a “back line”. A front line operates at the forefront to collect maintenance information to be used for maintaining the product such as recorded logs or the like. A back line provides rear-area support to analyze the maintenance information collected by a maintenance person of the front line. In such a case, maintenance persons having higher technical skill are put in the back line rather than in the front line.

FIG. 1 illustrates how maintenance information is collected. In FIG. 1, three devices denoted by 802 are products purchased by a customer (hereinafter, referred to as “target devices”). The REMCS (REMort Customer Support System) center is provided by the company that has produced/sold the products to use it for providing maintenance services to the customers.

A maintenance person of the front line collects the maintenance information of the target devices 802 and attaches the collected information to an e-mail to transmit it to the maintenance center. The transmission is performed via a mail server 801 on Internet 800. Relay devices (not illustrated) are used for the transmission of those e-mails.

The maintenance information is, for example, a log file including logs, the logs having been output from the operating system (OS) installed on the target device 802 or from dedicated tools provided by the company.

Conventional relay devices execute, for example, the maintenance information transmission process whose flowchart is illustrated in FIG. 2 in order to transmit the maintenance information collected by a maintenance person. In the transmission process, a request for the transmission of maintenance information made by a maintenance person is received (step S91), the received maintenance information is encrypted (step S92), the encrypted maintenance information is attached to an e-mail, and the e-mail is transmitted (step S93). Information is input into a transmission request so that the problem for which maintenance information was collected can be recognized.

In the maintenance center, a network such as a LAN is constructed, and a gateway 830, a mail server 810, and a server 820 for storing maintenance information (such as a database (DB) server) are connected to that LAN. Thereby, the transmitted e-mails are received by the server 820 via the mail server 801, the gateway 830, and the mail server 810. For this purpose, the server 820 includes a mail receiving unit 821 and a storage device (such as a hard disk device) 822 that includes a database 823 for storing the e-mails received by the receiving unit 821.

In this configuration, maintenance information is uploaded into the server 820 via the Internet 800 in the form of E-mail. The reason for using a communications network such as the Internet 800 as a telecommunication line for uploading is that carrying a transportable storage medium that has stored maintenance information is not desirable in view of security and also that communications networks are widely spread.

FIG. 3 illustrates transmission of maintenance information performed by a conventional relay device. A conventional relay device executes the transmission process illustrated in FIG. 2 in order to transmit (upload) maintenance information. Accordingly, maintenance information is transmitted by following the procedures according to instructions given by the maintenance person. In the example illustrated in FIG. 3, the maintenance person makes transmission requests to transmit information A, information B, and information C in that order so that pieces of information A through C are transmitted sequentially in the requested order.

Problems have to be responded to promptly, while the greater the size (data amount) of a piece of maintenance information, the longer the time it takes to upload the information. Also, when there are plural pieces of maintenance information collected from a single target device 802, such pieces of maintenance information usually have different levels of importance to a maintenance person (support person) in the back line that provides rear-area support in response to the problem. Usually, pieces of maintenance information have different importance levels depending on their content such as the emergency levels or the criticality. Thus, when information B is transmitted prior to the transmission of information C when information B is less important and larger in size than information C and information C is considered by a back-line maintenance person to be more important and is expected to arrive first, the arrival of information C is delayed and thus the response to the problem is also delayed. Thus, it is preferable to be emphasized that the greater the importance of a piece of maintenance information to a back-line maintenance person, the more promptly that piece of maintenance information is preferable to be uploaded if the problem is to be responded to promptly.

As already mentioned, a maintenance person in a front line operating at the forefront is usually less technically advanced than a maintenance person in a back line providing rear-area support. Thus, it can be said that a front-line maintenance person cannot be expected to upload the pieces of maintenance information that the back-line maintenance person wants. It is thought, therefore, that an arrangement is preferable to be prepared that priorly uploads, into a relay device used for uploading, maintenance information considered by a back-line maintenance person to be more important.

Japanese Laid-open Patent Publication No. 9-135259

Japanese Laid-open Patent Publication No. 6-104910

### SUMMARY

According to a system to which the present invention is applied, when a plurality of pieces of maintenance information obtained in a device that is a target of maintenance are to be transmitted to an information processing device (such as a server) via a telecommunications line by using a relay device (computer), the priority of each of the pieces of maintenance information is determined by referring to priority recognition information used for recognizing priority in transmitting the maintenance information, and the plurality of pieces of information are transmitted separately and sequentially to the information processing device via the telecommunication line on the basis of the determined priority.

The priority of each of the pieces of maintenance information is determined on the basis of priority recognition information, the order of each of the pieces of maintenance information is determined on the basis of the priority, and thereby a piece of maintenance information having high priority (importance) that is specified by the priority recognition information is transmitted with precedence regardless of the skill level of the maintenance person who collected the maintenance information.

The object and advantages of the invention will be realized and attained by unit of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 illustrates how maintenance information is collected;

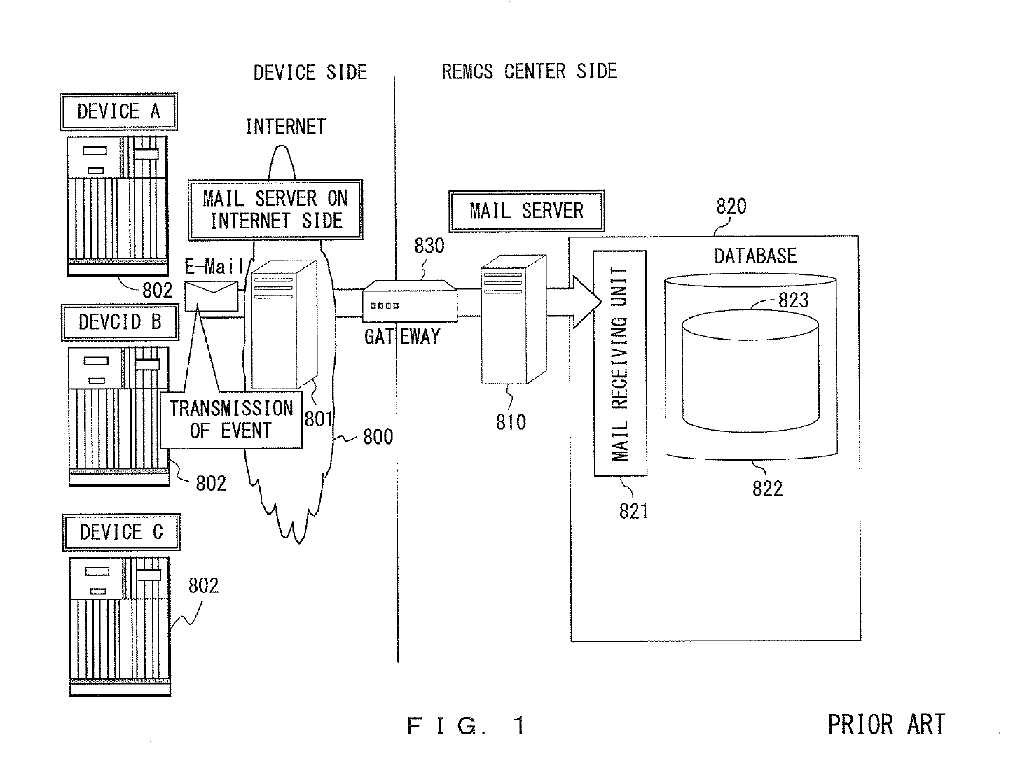

FIG. 2 is a flowchart for a conventional maintenance information transmission process;

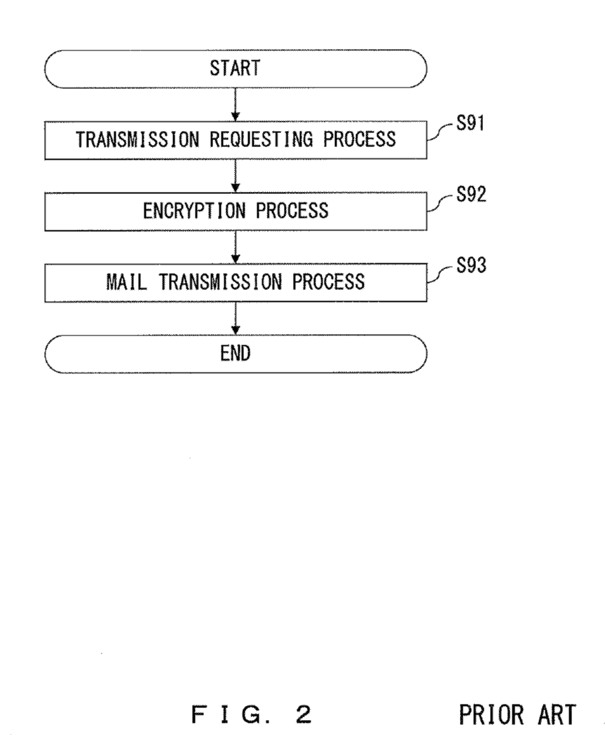

FIG. 3 illustrates transmission of maintenance information performed by a conventional relay device;

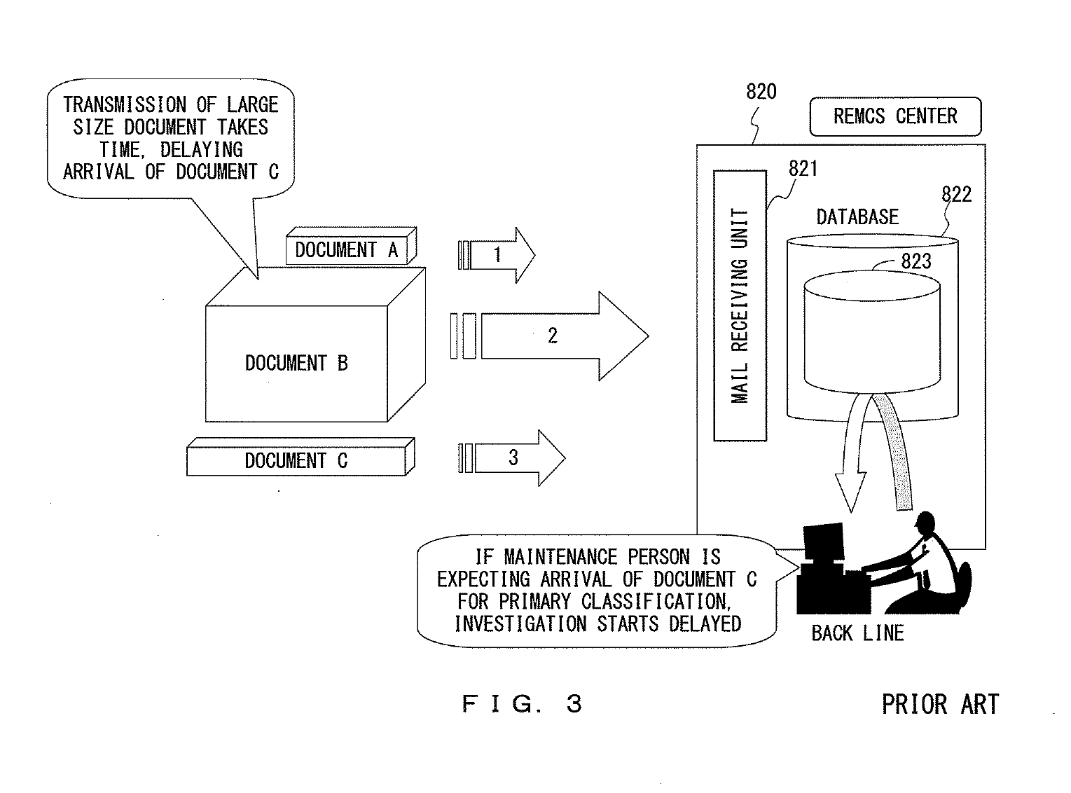

FIG. 4 illustrates a configuration of a network system configured using a relay device according to an embodiment;

FIG. 5 illustrates a functional configuration of a relay device 120 according to an embodiment;

FIG. 6 illustrates an example of the content of a transmission priority definition file 126;

FIG. 7 is a flowchart for a maintenance information transmission process;

FIG. 8 illustrates a functional configuration of a server 130;

FIG. 9 is a flowchart for a weight setting process; and

FIG. 10 illustrates an example of a hardware configuration according to an embodiment.

### DESCRIPTION OF EMBODIMENTS

Hereinafter, embodiments of the present invention will be explained by referring to the drawings.

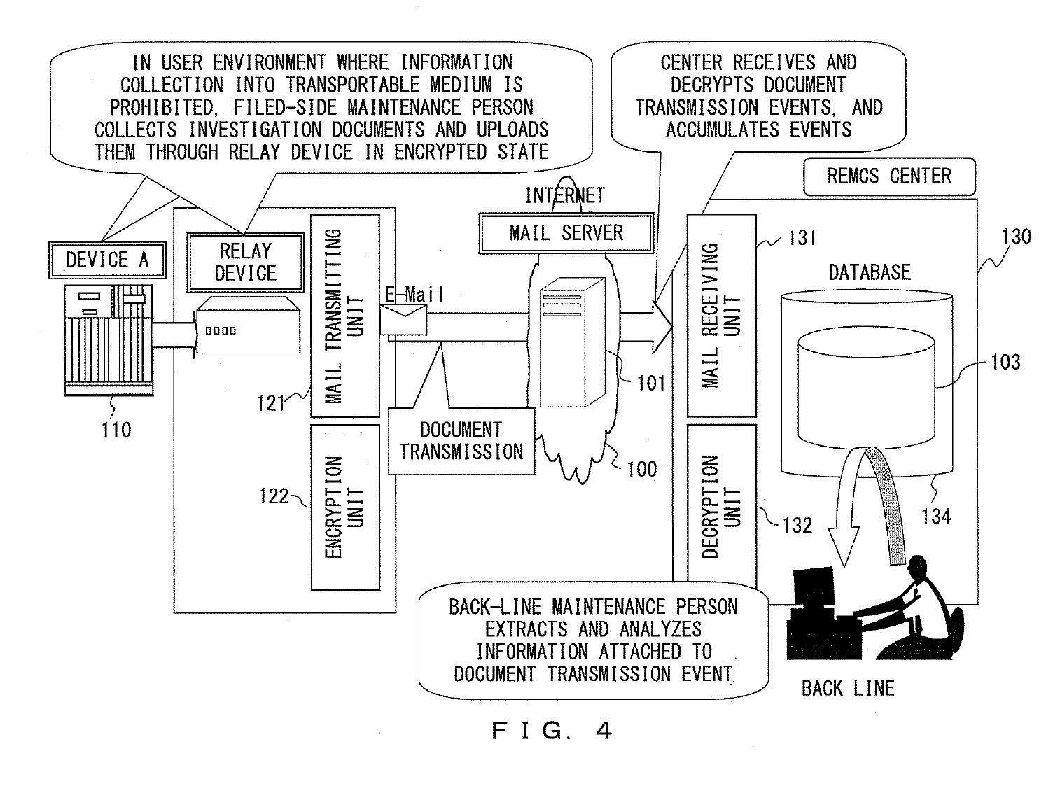

FIG. 4 illustrates a configuration of a network system configured using a relay device according to the present embodiment.

As illustrated in FIG. 4, a relay device 120 and a server 130 are connected to Internet 100 to form the above network system. The relay device 120 is for uploading, in the form of e-mail, maintenance information collected in a target device 110 that is a maintenance target, and the server 130 is provided in the REMCS center to receive the uploaded maintenance information (e-mail). In the Internet 100, there is a mail server 101 for relaying e-mails between the relay device 120 and the server 130.

The server 130 includes a mail receiving unit 131 for receiving e-mails from the server 101, a decryption unit 132 for decrypting the maintenance information attached to the e-mails, and a storage device (for example, a hard disk device or a large capacity storage device that can be accessed by the server) in which a DB 133 for storing the maintenance information is constructed.

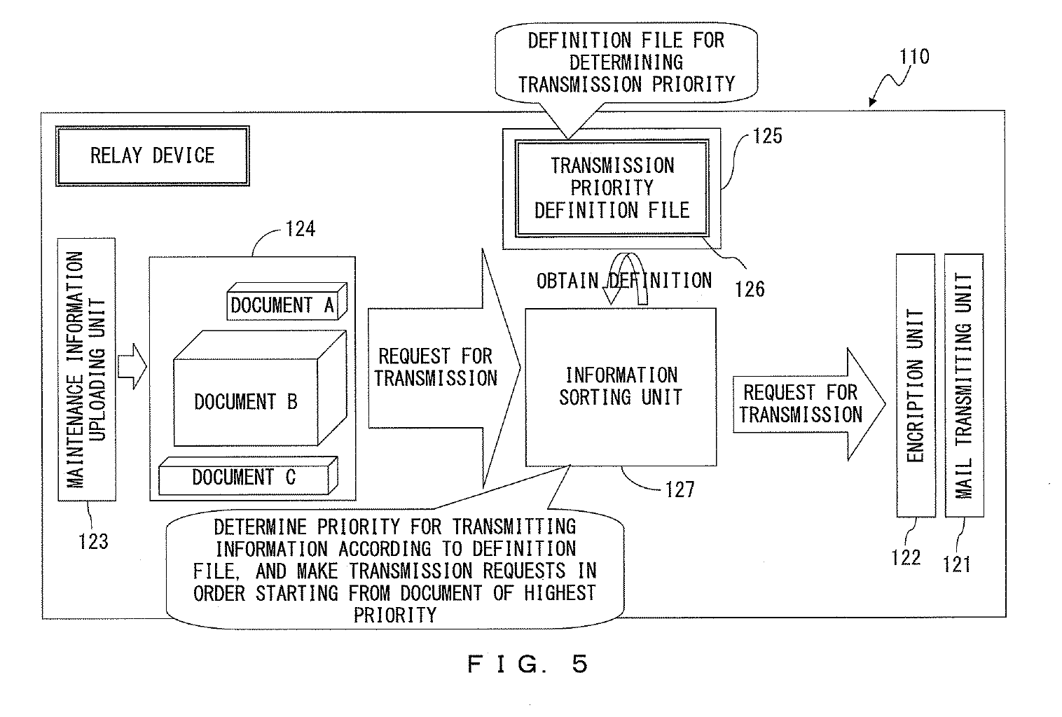

FIG. 5 illustrates a functional configuration of the relay device 120 according to the present embodiment. This relay device 120 includes the constituent elements described below in addition to a mail transmission unit 121 for transmitting e-mails and an encryption unit 122 for encrypting maintenance information.

In other words, as illustrated in FIG. 5, the relay device 120 includes a maintenance-information uploading unit 123, an information storage unit 124, a file storage unit 125, and an information sorting unit 127. The maintenance-information uploading unit 123 uploads, into the inside, maintenance information collected by a front-line maintenance person. The information storage unit 124 stores the maintenance information retrieved by the maintenance-information uploading unit 123. The file storage unit 125 stores a transmission priority definition file 126 including priority recognition information used for recognizing the priority of a plurality of pieces of maintenance information to be transmitted. The information sorting unit 127 refers to the transmission priority definition file 126 in order to determine the priority of each of the pieces of maintenance information, and transmits them in the order of the determined priority. Expressions “information A”, “information B”, and “information C” in the information storage unit 124 correspond to the maintenance information.

The relay device 120 is implemented by causing a computer having a communication function to execute a control program for making that computer operate as the relay device 120. That control program is referred to as a “relay program” hereinafter. The relay device 120 further includes a display control unit for displaying images on a display device or the like. The maintenance-information uploading unit 123 is a component for receiving maintenance information input in response to the instructions input, by a maintenance person, into the input device included in or connected to the relay device 120.

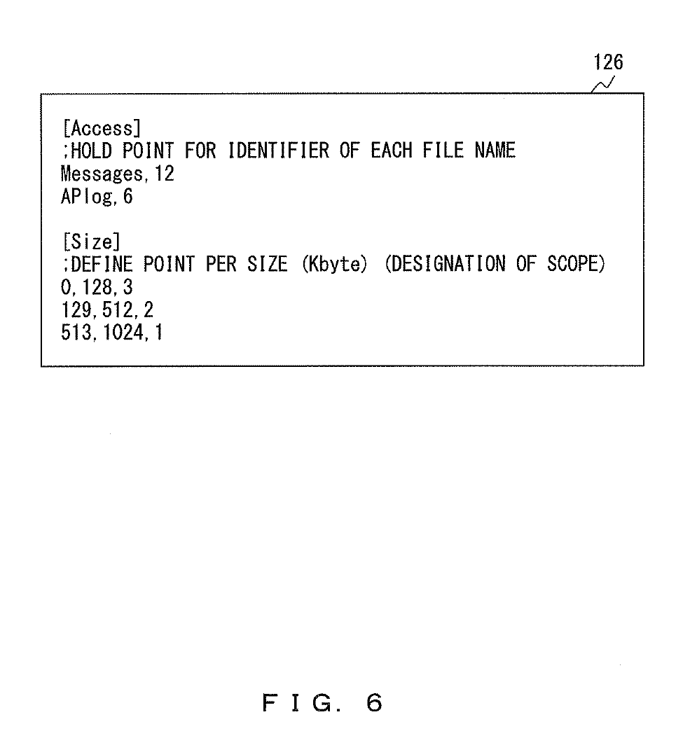

FIG. 6 illustrates an example of the content of the transmission priority definition file 126.

The transmission priority definition file 126 stores two types of priority recognition information. In the transmission priority definition file 126, as illustrated in FIG. 6, “Access” and “Size” are described as sections. The respective sections describe a plurality of pieces of priority recognition information having different view points. Specifically, the section “Access” describes recognition information (referred to as “priority type recognition information” for the sake of simplicity) used for recognizing priority in accordance with the type of maintenance information (the file including the maintenance information), and the section “Size” describes recognition information (referred to as “priority size recognition information” for the sake of simplicity) used for recognizing priority in accordance with the size of maintenance information (the file including the maintenance information).

In the present embodiment, the priority of maintenance information is determined by using two types of recognition information, and accordingly the point values representing the two pieces of priority of the respective pieces of recognition information are obtained in order to determine the final priority (priority order) on the basis of the result of the addition of the obtained point values. The higher the result of the addition, the higher the priority.

In the section “Access”, “Messages, 12” and “APlog, 6” correspond to the actual priority recognition information. For example, “Messages, 12” indicates that the point value of maintenance information whose file name includes “Messages” is “12”. An example of maintenance information whose file name includes “Messages” is a message output from the system. Similarly, “APlog, 6” indicates that the point value of the maintenance information whose filename includes “APlog” is “6”. An example of maintenance information whose file name includes “APlog” is a log. The point value of maintenance information whose file name corresponds to neither of them is “0”. The type of maintenance information may be identified using an identifier. Also, when priority in response varies according to the target device 110, maintenance information may be recognized according to the target device 110 that is to transmit the maintenance information.

In the section “Size”, “0, 128, 3”, “129, 512, 2”, and “512, 1024, 1” correspond to the actual priority size recognition information. For example, “0, 128, 3” indicates that the point value of the maintenance information is “3” when the size of the maintenance information is between “0” kilobytes and “128” kilobytes. This is applied also to the others. This recognition based on size is only an example, and does not limit the scope of the invention.

For example, as maintenance information for software, there are, in addition to log files, memory dump files that automatically store the content of memory that was being used by a program when the program terminated abnormally. Usually, memory dump files are of a low importance in analyzing the cause of abnormal termination while they are larger than log files in size. Accordingly, two pieces of recognition information are prepared so that maintenance information that is more important can be uploaded more surely and promptly.

The transmission priority definition file 126 prepares priority recognition information for each target device 110 or each target hardware/software in the target device 110. However, it is assumed herein that the transmission priority definition file 126 stores only the priority recognition information illustrated in FIG. 6 for the sake of simplicity. Accordingly, only problems in software are explained.

The information sorting unit 127 refers to priority size recognition information, identifies the point value corresponding to the size for each piece of the maintenance information stored in the information storage unit 124, and determines, according to the identified point values, the order of transmitting maintenance information. Thereafter, the information sorting unit 127 identifies the point value corresponding to the file name of the maintenance information by referring to the priority type recognition information, adds the identified point to the point value that has already been obtained, and determines the transmission order of the pieces of maintenance information on the basis of the result of the addition to transmit the pieces of maintenance information.

In the manner described above, pieces of maintenance information are automatically transmitted to a back-line maintenance person in the order of importance based on the point values. Thereby, even when a maintenance person makes requests for the transmission of maintenance information in the order of, for example, document A, document B, and document C, the actual transmission is performed in the order of, for example, document A, document C, and document B. As the order of transmitting maintenance information is automatically determined, a maintenance person can access important maintenance information with the minimum preferable transmission time or with a time close to the minimum preferable transmission time. This makes it possible to respond to problems promptly.

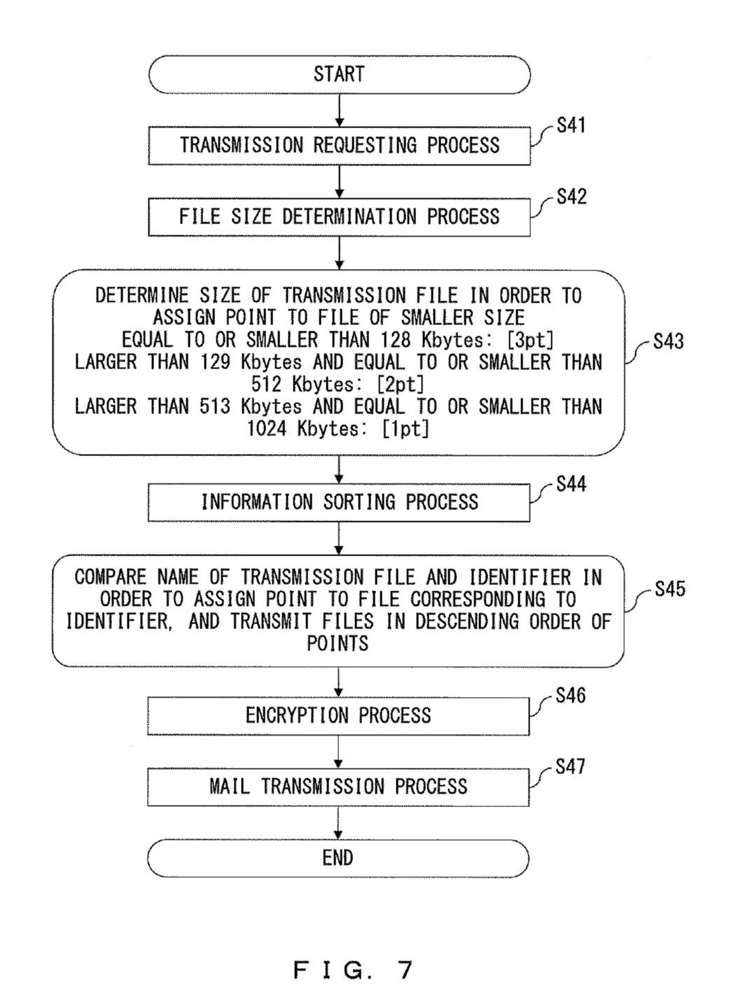

FIG. 7 is a flowchart for a maintenance information transmission process. This transmission process is implemented when the relay device 120 is activated to execute the above relay program by an instruction, to upload (transmit) maintenance information, given by a maintenance person operating the maintenance-information uploading unit 123. Next, FIG. 7 is referred to for explaining the transmission process in detail.

First, in step S41, a transmission requesting process is executed for receiving a request for transmitting maintenance information made by a maintenance person. Instep S42, a file size determination process is executed for each piece of maintenance information about which a transmission request was made so that the file size of the information is determined. In step S43, a point (value) is assigned to each piece of maintenance information according to the determined file size. The assignment of points is performed while referring to the priority size determination information in the transmission priority definition file 126. After the assignment of the point, the process proceeds to step S44.

In step S44, an information sorting process is executed for sorting pieces of maintenance information according to the assigned points. In step S45, points are further assigned to the sorted pieces of maintenance information by referring to the priority size recognition information in the transmission priority definition file 126 in order to set the order of transmitting pieces of maintenance information in descending order of the points after the further addition. Thereby, in steps S46 and S47, an encryption process and a mail transmission process are executed respectively for encrypting the maintenance information and attaching the encrypted information to E-mails to transmit them. When all pieces of maintenance information have been transmitted, this maintenance information transmission process is terminated.

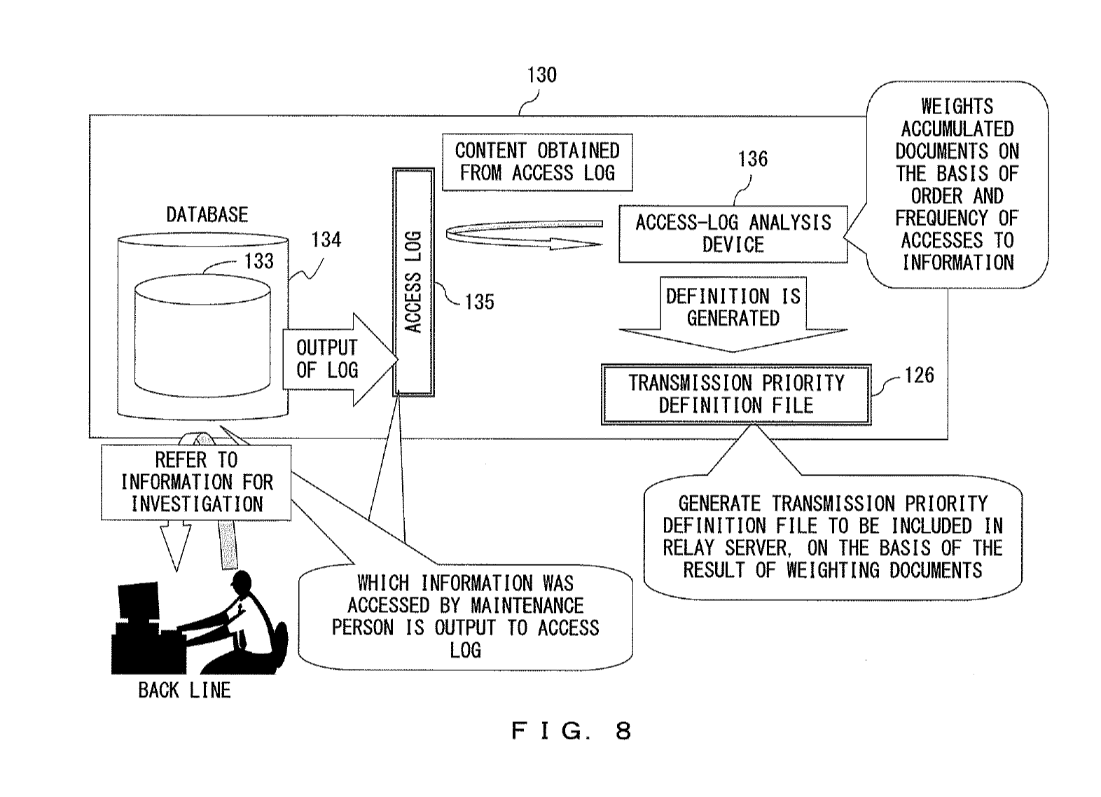

FIG. 8 illustrates a functional configuration of the server 130.

The server 130 includes, in addition to the mail receiving unit 131 and the decryption unit 132, an access-log analysis device 136 illustrated in FIG. 8.

Some problems in software are security incidents that can threaten the security of the information management or the operations of the system. They include infection with viruses, illegal accesses, information leaks, transmission of junk mail, DoS (Distributed denial of Service) attacks, etc.

When a security incident (problem) as described above has occurred, a back-line maintenance person accesses the uploaded maintenance information and analyzes the response. Accesses for the analysis are usually made firstly to maintenance information considered by a maintenance person to be important. This unit that the order of accesses made by a maintenance person indicates, at least to some extent, the importance admitted by the maintenance person or the effectiveness in finding the response. Accordingly, the access-log analysis device 136 monitors an access log 135 output on the basis of the accesses made by the maintenance person, and generates or updates priority determination information stored in the transmission priority definition file 126. The transmission priority definition file 126 in which the priority determination information was generated or updated by the access-log analysis device 136 is transmitted to the relay device 120 to be stored in the file storage unit 125. Thereby, in the present embodiment, maintenance information that is of a higher importance is surely transmitted with priority. The access-log analysis device 136 is included in the server 130 when the server 130 executes a program for implementing the function of the access-log analysis device 136 (hereinafter, referred to as “access log analysis program”).

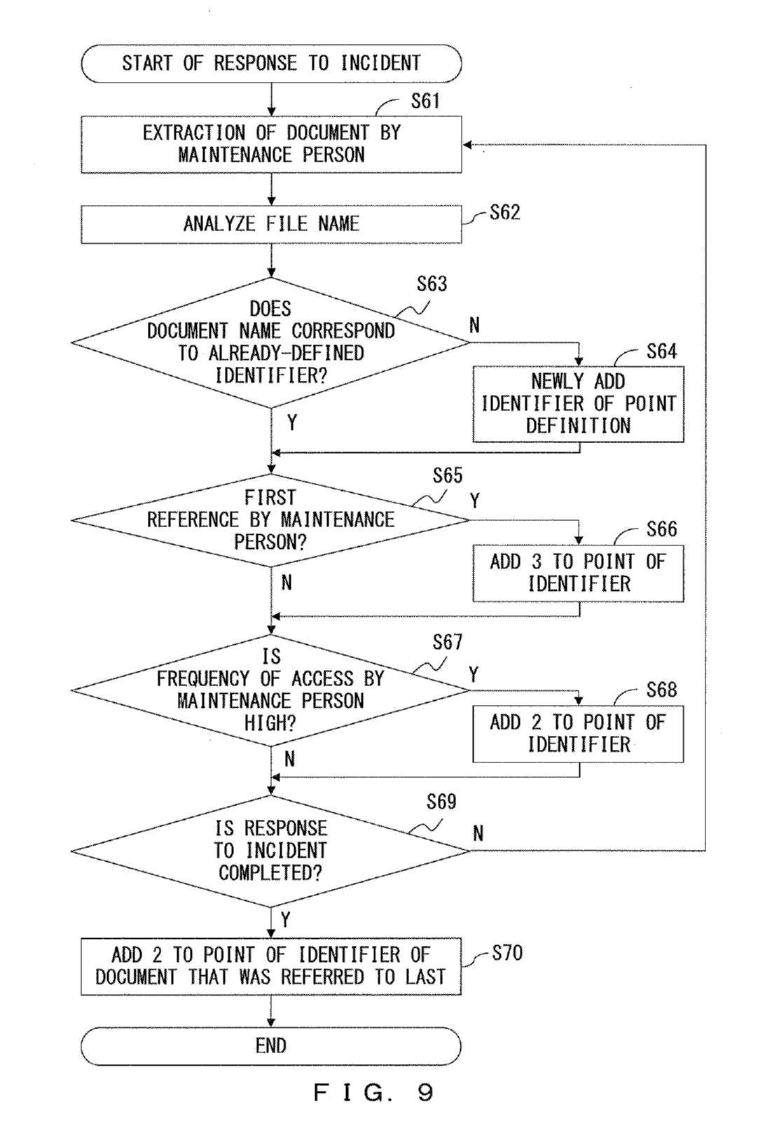

FIG. 9 is a flowchart for a weight setting process. This weight setting process is a process of setting a point value of each identifier of the priority type recognition information according to the order of the accesses made to the corresponding maintenance information by a maintenance person. This process is implemented by the execution of the above access log analysis program by the server 130. This process is activated by the start of the access made to the maintenance information by the maintenance person for responding to an incident, and is terminated when the response to the incident is completed. The start of the response to the incident can be recognized by the target device 110 (the software of the target device 110) about which the maintenance information is collected.

First in step S61, the process waits for the output of the access log 135 of the access made by a maintenance person (supporting person) to the maintenance information, and obtains the access log 135. In step S62, the file name stored in the access log 135 is analyzed. Thereafter, the process proceeds to step S63.

In step S63, it is determined whether or not the analyzed file name includes the identifier defined in the priority type recognition information in the transmission priority definition file 126. When the file name includes that identifier, the determination result is Yes, and the process proceeds to step S65. When the file name does not include that identifier, the determination result is No, and the part that corresponds to an identifier is extracted from the file name in step S64, and that part is newly defined in the priority type recognition information. Thereafter the process proceeds to step S65.

In step S65, it is determined whether or not the maintenance information is the information that was first referred to by the maintenance person. When the information is the maintenance information being referred to first, i.e., when this is the first execution of step S65 after the activation of this weight setting process, the determination result is Yes, and 3 is added to the point value of the identifier corresponding to that maintenance information in step S66, and thereafter, the process proceeds to step S67. When the information is not the maintenance information that was referred to first, the determination result is No, and the process proceeds to step S67.

An incident is sometimes responded to by plural maintenance persons. Accordingly, it is determined in step S67 whether or not the frequency of being accessed by maintenance persons is high. When the maintenance information is accessed more frequently than the predetermined number, the determination result is Yes, and 2 is further added to the point value of the identifier corresponding to that maintenance information in step S68. Thereafter, the process proceeds to step S69. When the access frequency is less than the predetermined number, the determination result is No, and the process proceeds to step S69.

In step S69, it is determined whether or not the response to the incident has been completed. When, for example, there has been no access made to the maintenance information related to this incident, it is determined that the response to this incident has been completed, and the determination result is Yes, making the process proceed to step S70. In step S70, 2 is further added to the point value of the identifier of the maintenance information that was referred to last, and thereafter this weight setting process is terminated. When it is determined that the response to the incident has not been completed, the determination result is No, and the process returns to step S61.

This determination of whether the response to the incident has been completed is performed as necessary. Thereby, when there has been no access to the maintenance information for the predetermined time or when the completion of the response to the security incident is reported from the maintenance person, the process proceeds to step S70.

As described above, priority type recognition information is updated, in other words, new priority type recognition information is generated. The transmission priority definition file 126 storing the priority recognition information that includes the generated priority type recognition information is transmitted from the server 130 to the relay device 120 via the Internet 1 as necessary. Then, the generated transmission priority definition file 126 is written in the relay device 120. The transmission priority definition file 126 may be written by a maintenance person. This method of updating priority type recognition information is only an example, and does not limit the scope of the invention.

Although the access-log analysis device 136 is included in the server 130 that manages maintenance information in the present embodiment, the access-log analysis device 136 may be included in a different device. Because priority type recognition information can be updated by obtaining the results of accesses made by a maintenance person in the back line, it is also possible to make the relay device 120 automatically or manually obtain those access results so that the relay device 120 updates the priority type recognition information. Thus, the access analysis device may also be implemented by a plurality of devices.

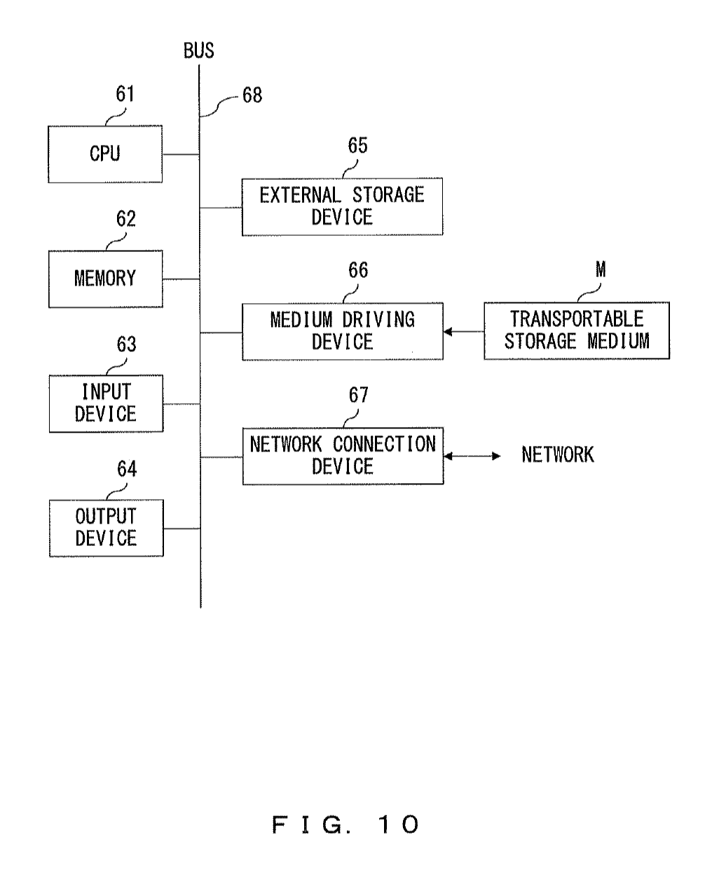

FIG. 10 illustrates an example of a hardware configuration according to an embodiment. A configuration of a computer that can be used as a relay device according to the present embodiment will be explained specifically by referring to FIG. 10.

The computer illustrated in FIG. 10 includes a CPU 61, memory 62, an input device 63, an output device 64, an external storage device 65, a medium driving device 66, and a network connection device 67, all of which are connected to each other via a bus 68. The configuration illustrated in FIG. 10 is only an example, and does not limit the scope of the present invention.

The CPU 61 operating as a processing unit reads programs onto the memory 62 to execute them in order to control the entire computer operating as the information processing device. The memory 62 operating as a storage device is semiconductor memory such as RAM or the like.

The input device 63 is, for example, an input interface connected to a handling device such as a keyboard, a mouse, or the like. The input device 63 detects manipulations on a handling device performed by a user, and transmits the detection results to the CPU 61.

The output device 64 is, for example, an output interface such as a display control device or the like that is connected to a display device. The network connection device 67 as a communications control device communicates with external devices via a communications network such as an intranet, the Internet, or the like. The external storage device 65 is, for example a hard disk device, and is used mainly for storing various types of data and programs.

The output device 64 accesses a transportable storage medium M such as an optical disk, a magneto-optical disk, or the like.

In the above configuration, the relay program (control program) is obtained by accessing the external storage device 65 or the transportable storage medium M, or via the network connection device 67. By making the CPU 61 execute a relay program available in this manner, the relay device 120 according to the present embodiment is implemented.

The information storage unit 124 is, for example, the memory 62, and the file storage unit 125 is, for example, the external storage device 65 and the memory 62 storing the information read from the external storage device 65. The maintenance-information uploading unit 123 is implemented, for example, by the CPU 61, the memory 62, the input device 63, the output device 64, and the external storage device 65. The information sorting unit 127 and the encryption unit 122 are implemented, for example, by the CPU 61, the memory 62, and the external storage device 65. The encryption unit 122 is implemented, for example, by the CPU 61, the memory 62, the external storage device 65, and the network connection device 67.

A computer of the above configuration can also be used as the access-log analysis device 136. When this computer is used as the access-log analysis device 136, the access log analysis program is stored, for example, in the external storage device 65. When this computer is used as the server 130, the access-log analysis device 136 is implemented, for example, by the CPU 61, the memory 62, and the external storage device 65. When this computer is not used as the server 130, the access-log analysis device 136 is implemented, for example, by the CPU 61, the memory 62, the external storage device 65, and the network connection device 67. The network connection device 67 is used for obtaining the access log 135.

As described above, the adaptation of the present invention makes it possible that when a plurality of pieces of maintenance information obtained in a device that is a maintenance target are to be transmitted by a relay device (computer) to an information processing device (such as a server) via an electric communications line, priority recognition information used for recognizing the priority in transmitting the plurality of pieces of maintenance information is referred to in order to determine the priority of each piece of the maintenance information, and the plurality of pieces of maintenance information are transmitted to the information processing device via the electric communications line separately and sequentially in accordance with the determined priority.

The priority of each piece of maintenance information is determined on the basis of priority recognition information so that the priority in transmitting the maintenance information is determined, and accordingly a piece of maintenance information that is specified by the priority recognition information to be of high priority (importance) is transmitted priorly regardless of the skill level of the maintenance person who collected the maintenance information. As a result of this, a maintenance person in the back line can always refer to important maintenance information at an earlier stage. This makes responses to problems more prompt.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority or inferiority of the invention. Although the embodiment of the present invention has been described in detail, it is preferable to be understood that various changes, substitutions, and alterations could be made hereto without departing from the spirit and scope of the invention.

1. A method of transmitting, to an information processing device via a telecommunications line by using a computer, maintenance information obtained from a target device that is a target of maintenance, comprising:
determining priority of each piece of maintenance information by referring to priority recognition information used for recognizing priority in transmitting the maintenance information when a plurality of pieces of maintenance information are to be transmitted, said priority recognition information being stored in storage unit; and
transmitting each of the plurality of pieces of maintenance information to the information processing device via the telecommunications line on the basis of the priority determined in the determination step.

2. A relay device that transmits, to an information processing device via a telecommunications line, maintenance information obtained in a target device that is a target of maintenance, comprising:
information obtaining unit capable of for obtaining the maintenance information;
information storage unit capable of for storing priority recognition information used for recognizing priority in transmitting respective a plurality of pieces of maintenance information when a plurality of pieces of maintenance information are obtained from the information obtaining unit;
priority determination unit capable of for determining priority of each of the plurality of pieces of maintenance information by referring to the priority recognition information stored in the information storage unit; and
information transmission unit capable of for transmitting each of the plurality of pieces of maintenance information to the information processing device via the telecommunications line on the basis of the priority determined by the priority determination unit.

3. The relay device according to claim 2, wherein:
the priority recognition information includes first recognition information used for recognizing the priority on the basis of a data amount of the maintenance information, and second recognition information used for recognizing the priority on the basis of a type of the maintenance information; and
the priority determination unit determines the priority for each piece of maintenance information on the basis of the first recognition information and the second recognition information.

4. The relay device according to claim 2, wherein:
the priority recognition information is generated on the basis of a result of accessing transmitted maintenance information.

5. An access analysis device connected via a telecommunications line to a relay device that, when a plurality of pieces of maintenance information are obtained from a target device that is a target of maintenance, transmits the plurality of pieces of maintenance information on the basis of priority of the plurality of pieces of maintenance information by referring to priority recognition information used to recognize priority in transmitting respective pieces of maintenance information, comprising:
access monitoring unit for monitoring an access made, by the relay device, to maintenance information transmitted to the information processing device;
priority calculation unit capable of for calculating, on the basis of a result of monitoring performed by the access monitoring unit, priority in transmitting maintenance information of a type that was accessed; and
update unit capable of for updating the priority recognition information by using the priority calculated by the priority calculation unit.

6. The access analysis device according to claim 5, wherein:
the update unit registers in the priority recognition information the type of the maintenance information when the type of the maintenance information to which access was monitored by the access monitoring unit is not registered in the priority recognition information.

7. The access analysis device according to claim 5, wherein:
the calculation unit calculates, as a result of monitoring performed by the access monitoring unit, a value representing the priority on the basis of an order and frequency of accesses made to the maintenance information.

8. A method of controlling a relay device that transmits, to an information processing device via a telecommunications line, maintenance information obtained from a target device that is a target of maintenance, said method comprising:
obtaining the maintenance information by an information obtainment unit;
storing priority recognition information being used to recognize priority in transmitting respective a plurality of pieces of maintenance information in an information storage unit, when a plurality of pieces of maintenance information are obtained by the information obtainment unit;
determining priority of each of a plurality of pieces of maintenance information by referring to the priority recognition information stored in the information storage unit by a priority determination unit; and
transmitting to the information processing device each of the plurality of pieces of maintenance information via the telecommunications line on the basis of the priority determined by the priority determination unit by an information transmission unit transmits.

9. A recording medium that can be accessed by a computer used as a relay device that transmits, to an information processing device and a telecommunications line, maintenance information obtained from a target device that is a target of maintenance, said medium storing a control program causing the computer to implement, the control program comprising:
an information obtaining function of obtaining the maintenance information;
a priority determination function of determining priority of each of a plurality of pieces of maintenance information by referring to priority recognition information stored in storage unit and used for recognizing priority in transmitting the respective pieces of maintenance information when a plurality of pieces of maintenance information are obtained by the information obtaining function; and
an information transmission function of transmitting each of the plurality of pieces of maintenance information to the information processing device via the telecommunications line on the basis of the priority determined by the priority determination function.

10. A recording medium that can be accessed by a computer used as an access analysis device connected via a telecommunications line to a relay device that transmits, to an information processing device, a plurality of pieces of maintenance information by referring to priority recognition information used for recognizing priority in transmitting the respective pieces of maintenance information when a plurality of pieces of maintenance information are obtained from a target device that is a target of maintenance, said medium storing a control program causing the computer to implement, the control program comprising:
an access monitoring function of monitoring an access made, by the relay device, to maintenance information transmitted to the information processing device;
a priority calculation function of calculating, on the basis of a result of monitoring performed by the access monitoring function, priority in transmitting maintenance information of a type that was accessed; and
an update function of updating the priority recognition information by using the priority calculated by the priority calculation function.
